(19) United States
(12) Patent Application Publication
(10) Pub. No.: US 2025/0354662 A1
(43) Pub. Date: Nov. 20, 2025

(54) DIFFUSER, TANK AND PURGING METHOD

(71) Applicant: Faurecia Hydrogen Solutions France, NANTERRE (FR)

(72) Inventors: Benjamin OBLINGER, FROTEY-LES-LURE (FR); Edouard NAULIN, BELFORT (FR)

(21) Appl. No.: 19/207,978

(22) Filed: May 14, 2025

(30) Foreign Application Priority Data
May 17, 2024 (FR) 24 05112

(51) Int. Cl. F17C 13/00

(52) U.S. Cl. CPC F17C 13/00; F17C 2201/0109; F17C 2205/0323; F17C 2205/0391; F17C 2221/012; F17C 2227/044

(57) ABSTRACT

An apparatus comprises a diffuser for a tank for pressurized gas, such as hydrogen, wherein the diffuser is internal to the tank and designed to inject pressurized gas. An assembly comprises a tank that includes such a diffuser.

A method for sweep purging such a tank includes using a purging tool.

### CROSS-REFERENCE TO RELATED APPLICATION

This application is a U.S. non-provisional application claiming the benefit of French Application No. 24 05112, filed on May 17, 2024, which is incorporated herein by reference in its entirety.

### TECHNICAL FIELD

The disclosure relates to a diffuser for a tank of pressurized gas, such as hydrogen, where the diffuser is internal to the tank and shaped to inject pressurized gas.

### BACKGROUND

The purging of a gas tank is the operation that allows a new gas to replace a new one, until the concentration of new gas in the tank exceeds a given threshold.

It is known to use a dilution method to purge a tank initially containing an old gas. In such a method, the first step is to fill the tank with new pressurized gas. The tank then contains a mixture of the new gas and the old gas. In a second step, the gas mixture contained in the tank is drawn off. The purging is continued by repeating the cycle of these two steps in succession. With each repetition, the mixture becomes richer and richer in new gas, and less and less rich in old gas. The method is stopped as soon as the concentration of new gas is deemed acceptable, that is above a given threshold.

One advantage of such a method is that it can be carried out by use of a single fluidic device, usable for both filling and drawing off, and therefore generally pre-existing on any tank, such a fluidic device being necessary for its nominal use.

A major drawback of such a method is that it requires a large number of dilution cycles, resulting in prohibitively long purging.

An alternative to the dilution process has therefore been sought.

### SUMMARY

The disclosure provides a method for purging a tank by sweeping. The principle of a sweep purging method is to inject new gas through one fluidic device and simultaneously recover the gas mixture through another fluidic device. Such a method requires a tank suitable for purging by sweeping. A diffuser is used to facilitate sweep purging.

The disclosure relates to a diffuser for a tank of pressurized gas, such as hydrogen, wherein said diffuser is internal to the tank and designed to inject pressurized gas.

Particular features or embodiments, usable alone or in combination, are:
the diffuser is extended by at least one channel forming an angle of less than 90° with the diffuser,
said at least one channel comprises at least two channels angularly equispaced around the diffuser,
said at least two channels are not coplanar with the diffuser so as to swirl the injected gas
said at least one channel is 360° circular around the diffuser,
said at least one channel rotates around the diffuser.

The disclosure further relates to a tank for pressurized gases, such as hydrogen, comprising such a diffuser.

Particular features or embodiments, usable alone or in combination, are:
the tank comprises a first fluidic device, comprising at least one first valve suitable for allowing the tank to be drawn off, and a second fluidic device, including at least one second valve suitable for allowing the tank to be filled, wherein the second fluidic device comprises the diffuser,
the first fluidic device is arranged at a first end of the tank and the second fluidic device is arranged at a second end of the tank opposite the first end.

The disclosure further relates to a method for sweep purging a tank, using a purging tool, comprising the following steps:
connecting an outlet of the purging tool to the second valve, and connecting an inlet of the purging tool to the first valve, simultaneously or in any order,
opening the first valve, and possibly opening the second valve, simultaneously or in any order,
supplying new pressurized gas via the outlet of the purging tool and recovering the outgoing gas via the inlet of the purging tool, for a predetermined purging time,
closing the first valve,
stopping the gas supply when the desired gas pressure is reached in the tank,
if necessary, closing the second valve.

### BRIEF DESCRIPTION OF THE DRAWINGS

The disclosure will be better understood on reading the following description, given solely by way of example, and with reference to the appended figures in which:

FIG. 1 shows, in an axial cross-sectional view, a tank according to a first embodiment;

FIG. 2 shows, in an axial cross-sectional view, a tank according to a second embodiment;

FIG. 3 shows, in an axial cross-sectional view, a tank end;

FIG. 4 shows, in front view, the end of FIG. 3;

FIG. 5 shows the principle of sweep purging;

FIG. 6 shows, in longitudinal cross-sectional view, a first embodiment of the diffuser;

FIG. 7 shows, in perspective view, the diffuser of FIG. 6;

FIG. 8 shows, in longitudinal cross-sectional view, the diffuser of FIG. 6;

FIG. 9 shows, in longitudinal view, another embodiment of the diffuser;

FIG. 10 shows, in transverse cross-sectional view, a detail of the diffuser of FIG. 9;

FIG. 11 shows, in perspective view, another embodiment of the diffuser; and

FIG. 12 shows, in longitudinal view, the diffuser of FIG. 11.

### DETAILED DESCRIPTION OF THE DRAWINGS

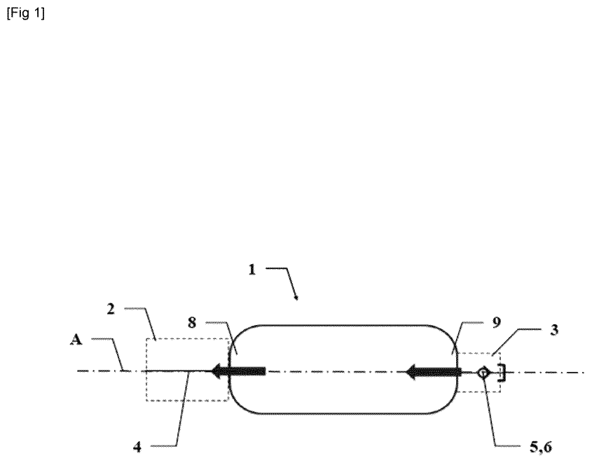

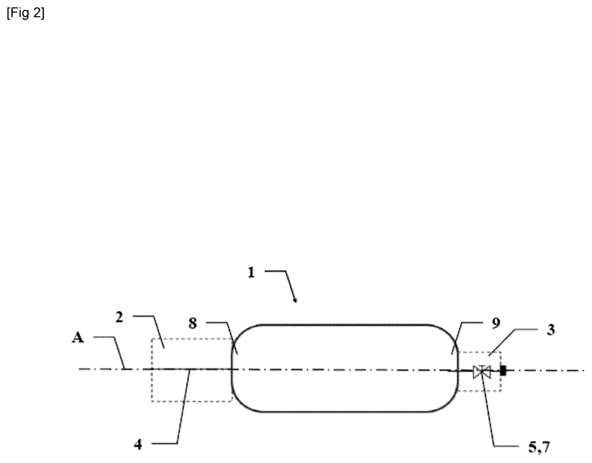

Referring to FIG. 1 or 2, the disclosure relates to a tank 1 for pressurized gas, such as hydrogen. This tank 1 comprises a first fluidic device 2. For the purposes of the purging method, this first fluidic device 2 comprises at least one first valve 4, suitable for being used to draw from the tank 1. This first fluidic device 2 may have other functions. Advantageously, this first fluidic device 2 is the fluidic device 2, known from the prior art, which is used throughout the life cycle of a tank 1. It's also known as OTV (On-Tank Valve). Such a fluidic device 2 can be used to draw from and fill the tank 1. It also provides monitoring and safety functions, such as pressure and/or temperature monitoring, or gas release in the event of critical overpressure.

According to a feature specific to an adaptation to a sweep purging method, the tank 1 further comprises a second fluidic device 3. This second fluidic device 3 may be referred to as an “End Plug” (EP). This second fluidic device 3 comprises at least one second valve 5, suitable for use in filling.

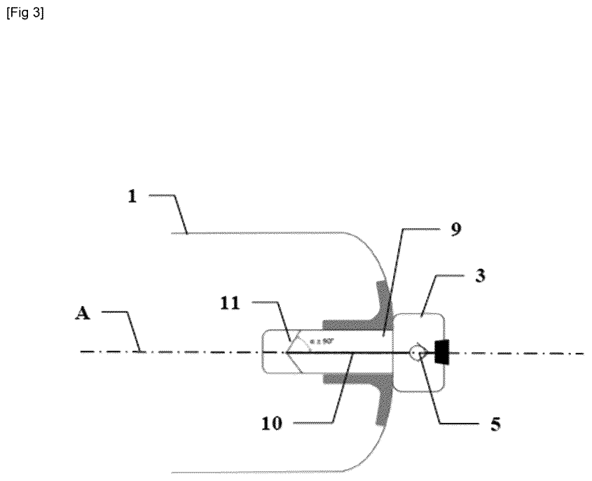

As shown in FIG. 3, according to a further feature, the second fluidic device 3 further comprises a diffuser 10. This diffuser 10 is internal to the tank 1 and is directed towards the interior of the tank 1, substantially along the axis A, connecting the first fluidic device 2 to the second fluidic device 3. It connects the second fluidic device 3 with the inside of the tank 1. This diffuser 10 is designed to inject a pressurized gas into the tank 1.

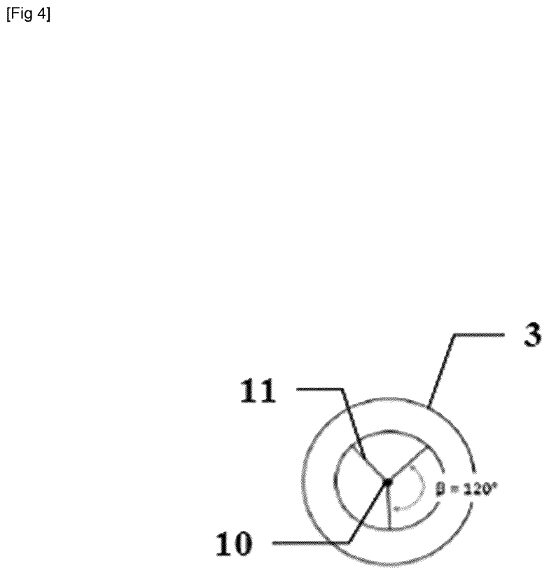

As shown in FIGS. 3 and 4, another advantageous feature is that the diffuser 10 is extended inwards by at least one channel 11. Said at least one channel 11 advantageously forms an angle α of less than 90° with the diffuser 10, and therefore with the axis A. In addition, this channel 11 allows the new gas, introduced through the second valve 5, to be “blown” towards the counter-current, stop, or dead zones at the bottom of the tank 1, which would otherwise remain beyond the reach of the sweep.

The length of the pressurized gas jet can be easily adjusted by modulating the cumulative flow cross-section of the nozzle(s) 11 relative to the flow cross-section of the diffuser 10.

According to another advantageous feature, said at least one channel 11 comprises at least two channels 11 and preferentially three or four channels 11. These channels 11 are advantageously angularly equispaced around the diffuser 10. FIG. 4 shows an example with three channels 11, arranged every β=120°. Multiplying the number of channels 11 can advantageously improve the dead zone sweeping effect. Equal distribution of channels 11 helps to homogenize the sweep.

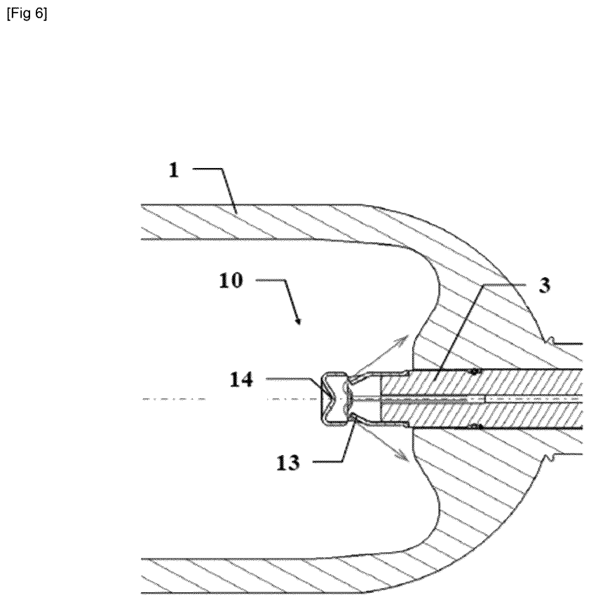

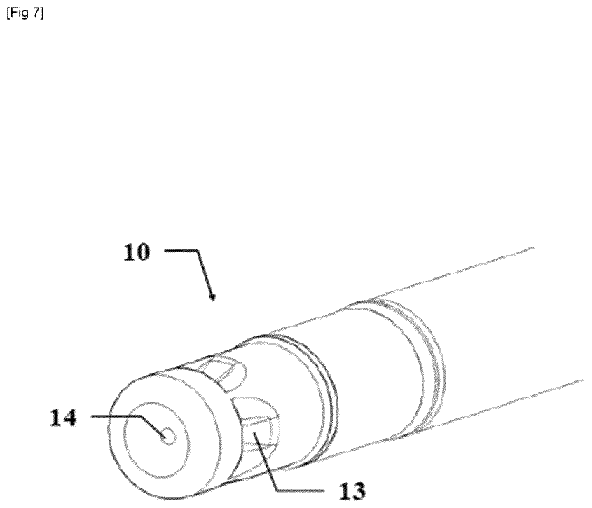

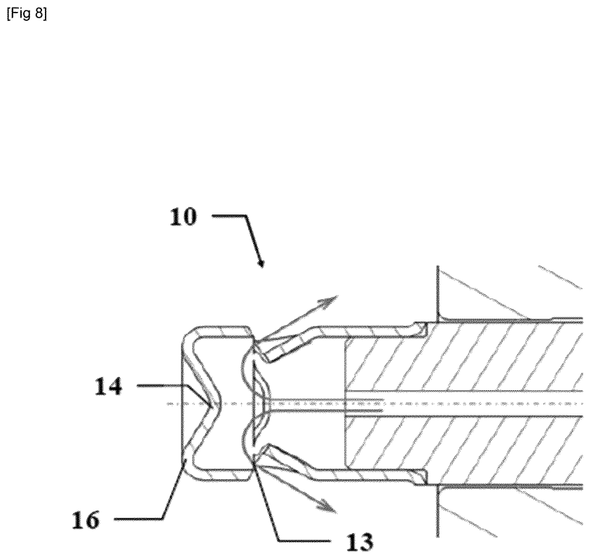

This acute-angle feature is shown by the diffuser 10 shown in FIGS. 6-8. This diffuser 10 is made of pressed sheet metal. It can be sheet metal, such as a light alloy. Alternatively, such a diffuser 10 can be made of plastic, typically by injection molding. This diffuser 10 comprises a mainly cylindrical body, suitable for being force-fitted onto the end of a pipe of the second device 3. At its other end, the diffuser 10 comprises a cap 16 with a cavity 14 to help direct the diffused gas jets. The sides of the diffuser 10 are pierced by lumens 13. These lumens 13 form the channels 11. The shape of the lumens 13 allows gas jets to be directed at an acute angle α. This embodiment is a simple and inexpensive way of producing the diffuser.

According to another feature, said at least two channels 11 are not coplanar with the diffuser 10. This angular offset, which is advantageously identical for all channels 11, creates a tangential component that swirls the injected gas. This vortex improves the purging of the tank 1.

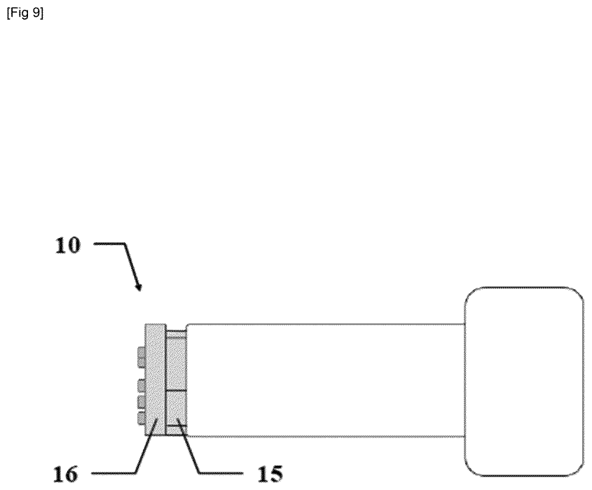

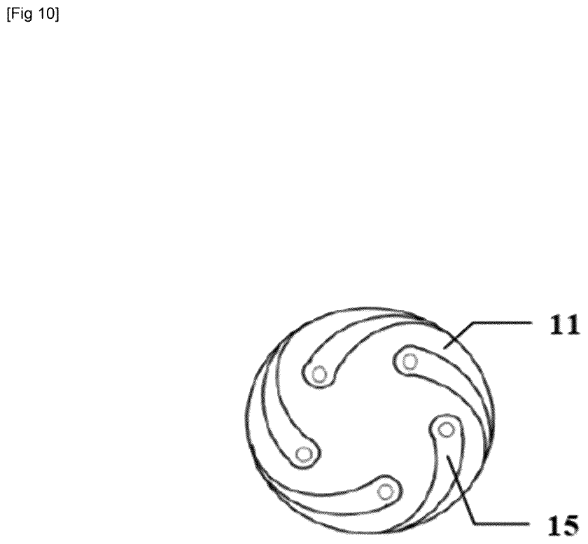

This vortex feature is shown by the embodiment of a diffuser 10 shown in FIGS. 9 and 10. In this embodiment, the diffuser 10 comprises a stage assembling vanes 15 before an end cap 16.

These vanes 15 form between them the channels 11. The radially curved shape of these channels 11 produces a vortex effect that entrains the gas jets.

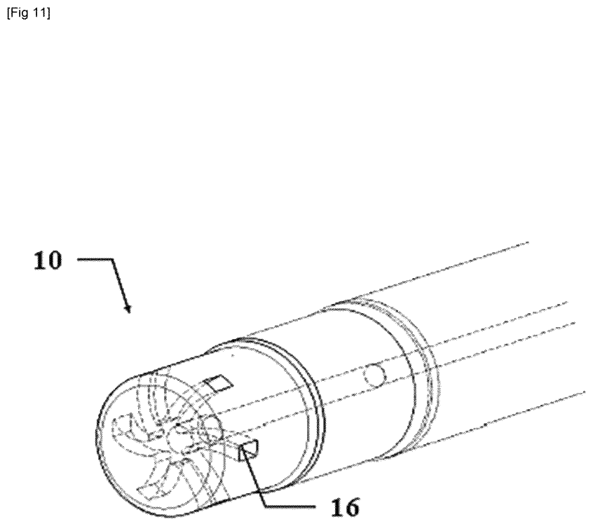

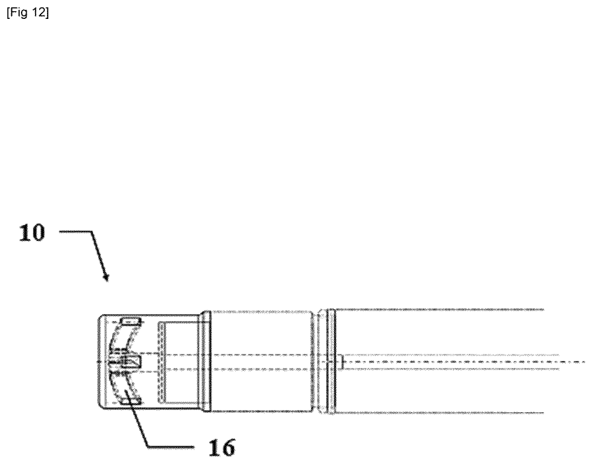

It is, of course, possible to combine the two above features, acute angle and vortex. This is shown by the embodiment of a diffuser 10 shown in FIGS. 11 and 12. Conduits 16 are formed inside this diffuser 10. These conduits 16 form the channels 11. They are at an acute angle to the axis. They also have a radially curved shape, so that they are not coplanar with the diffuser 10. In this way, they induce a swirling effect applied to the gas jets, while directing said gas jets towards the dead zones of the tank 1.

According to another feature (not shown), generalizing the feature of proliferating channels 11, the number of channels 11 is increased to infinity, creating a single 360° circular channel 11, of revolution around the diffuser 10. This produces a conical jet, increasing the area swept by the pressurized gas.

According to another feature (not shown), said at least one channel 11 rotates around the diffuser 10. Such rotation can be achieved, both for discrete channels 11 and for a single, circular channel, by a rotational degree of freedom, obtained by any known way, complemented by the previous characteristic of non-coplanarity. In this way, the channel(s) 11 are free to rotate around the diffuser 10, and the passage of pressurized gas through the channel(s) 11 produces the rotation.

According to another feature, the second valve 5 is a non-return valve 6. This non-return valve (6) is oriented so as to be open in the direction from the outside to the inside of tank 1, and obstructive in the other direction. This preferred design allows the purging method to be automated, as the second valve 5 is opened by applying purging pressure in the direction from the outside to the inside of tank 1, without manual intervention.

According to another feature, the second valve 5 is a simple valve 7, preferentially manual. Such a simple manual valve 7 is advantageously less expensive than the non-return valve 6 of the previous design. However, this embodiment is a degraded embodiment relative to the previous one, in that it requires manual operation of the simple valve 7 to open it when purging pressure is applied.

According to another feature, the second valve 5 comprises a non-return valve 6 and a simple valve 7, preferentially manual, connected in series. This ensures redundant sealing to the outside. Although more costly than the previously described methods, this embodiment improves the safety of the tank 1.

According to a further feature, the first fluidic device 2 is arranged at a first end 8 of the tank 1 and the second fluidic device 3 is arranged at a second end 9 of the tank 1, opposite the first end 8.

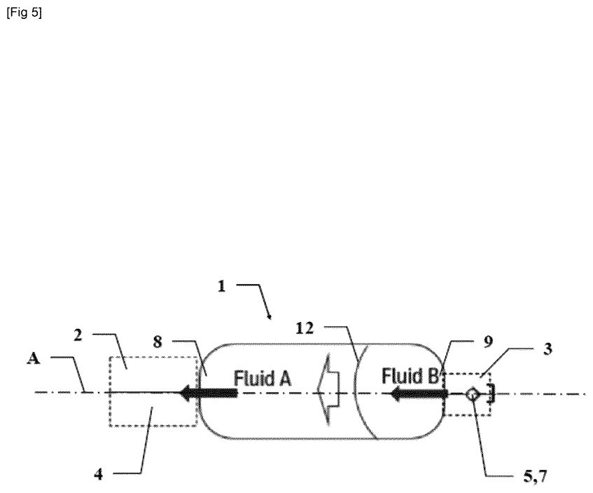

Even more advantageously, for a tank 1 with a longitudinal extension along an axis A, the two fluidic devices 2, 3 are preferentially arranged at the respective ends of this extension. In this way, a front 12 between the old “fluid A” gas and the new “fluid B” gas has the smallest possible surface area, that is the cross-section of tank 1 perpendicular to the axis of extension. As shown in FIG. 5, this optimizes the scavenging of the old “fluid A” gas by the new “fluid B” gas during purging, thus facilitating and/or accelerating purging.

The disclosure further relates to a method for sweep purging such a tank 1. This method uses a purging tool. The purging tool typically comprises a first pipe comprising an outlet connector adapted to be sealingly connected to the second valve 5 and adapted to be fed by a new gas supply, comprising, for example, a new gas tank and a pump. The purging tool further comprises a second pipe with an inlet connector that can be sealingly connected to the first valve 4, to enable the gas mixture leaving the tank 1 to be discharged and, if necessary, recovered. In its simplest version, the second pipe comprises a vent channel. Alternatively, it comprises a storage member, such as a tank, suitable for storing the outgoing mixture.

The purging method comprises the following steps. The purging tool is placed on the tank 1 to be purged. To do this, in a first step, its output is connected to the second valve 5, and in a second, earlier, simultaneous or later step, its input is connected to the first valve 4.

In a third step, the first valve 4 is opened. If this first valve 4 is an OTV draw-off valve, it may be a solenoid valve that can be electrically controlled by a control device, possibly grouped or integrated with the purging tool control. Alternatively, it can also be a manual valve, operated either manually or by way of a tool. This first open valve 4 allows the gas mixture to be drawn off/drained from the tank 1.

In a fourth subsequent step, the second valve 5 may be opened. This opening is optional, as it is not necessary according to the embodiment. In the case of a simple valve 7, this valve must be open. On the other hand, in the case of a non-return valve 6, opening is automatically triggered by the supply of new gas to the next stage.

The third and fourth steps can be carried out in this order, simultaneously or in reverse order.

In a subsequent fifth step, the new pressurized gas is supplied via the outlet of the purging tool. This introduces new gas into the tank 1 via second valve 5.

This causes the gas, a mixture of new and old gas, to exit via the first valve 4. This gas mixture may be recovered via the inlet of the purging tool.

This new gas delivery step, which effectively carries out the scavenging purge, is maintained for a predetermined purging time. This purging time is determined so as to achieve a desired final concentration of new gas (or, equivalently, a residual concentration of old gas).

This determination can be carried out in advance by using tests or a numerical simulation.

Alternatively, after holding for a pre-determined period of time, the continued supply of new gas can be made dependent on a measurement of the actual concentration, compared with a target concentration.

Once the target, elapsed time, and concentration have been deemed reached or the concentration actually reached, in a sixth step, the first valve 4 is closed.

The supply of new gas is advantageously maintained until a desired gas pressure is reached in the tank 1. Here again, this pressure can be deemed to have been reached after a predetermined time, or actually reached through servo control based on an actual pressure measurement. This stage ends with a stop to the supply of new gas.

A possible final step is to close the second valve 5. This is necessary in the case of a simple valve 7. This is not necessary in the case of a non-return valve 6, which closes by itself when the pressure stops.

Compared to a dilution purging method, sweep purging takes drastically less time. By way of illustration, purging a given tank by dilution takes 1919 seconds to reach a residual concentration of 4% of old gas, whereas sweep-purging the same tank takes 53 seconds to reach the same concentration. Purging the same tank by dilution takes 3755 seconds to reach a residual concentration of 0.4% of old gas, whereas sweep-purging the same tank takes 100 seconds to reach the same concentration.

There is a substantial advantage, in terms of time and therefore cost, in proceeding according to the disclosure, by sweeping.

The disclosure has been illustrated and described in detail in the drawings and the preceding description. This must be considered as illustrative and given by way of example and not as limiting the disclosure to this description alone. Many alternative embodiments are possible.

### LIST OF REFERENCE SIGNS

1: tank,
2: first fluidic device,
3: second fluidic device,
4: first valve,
5: second valve,
6: non-return valve,
7: simple valve,
8: first end,
9: second end,
10: diffuser,
11: channel,
12: front,
13: lumen,
14: cavity,
15: vane,
16: cap,
17: conduit,
A: axis,
α, β: angle.

1. An apparatus comprising:
a diffuser for a tank for pressurized gas, wherein the diffuser is internal to the tank and is configured to inject pressurized gas.

2. The apparatus according to claim 1, where the diffuser is extended by at least one channel forming, with the diffuser, an angle of less than 90°.

3. The apparatus according to claim 2, wherein said at least one channel comprises at least two channels angularly equispaced around the diffuser.

4. The apparatus according to claim 3, wherein said at least two channels are not coplanar with the diffuser so as to swirl injected gas.

5. The apparatus according to claim 2, wherein said at least one channel is 360° circular around the diffuser.

6. The apparatus according to claim 2, wherein said at least one channel is rotary around the diffuser.

7. An assembly comprising:
a tank for pressurized gas that includes the diffuser according to claim 1.

8. The assembly according to claim 7, including a first fluidic device comprising at least one first valve configured to draw off the tank, and a second fluidic device comprising at least one second valve configured to fill the tank, wherein the second fluidic device comprises the diffuser.

9. The assembly according to claim 8, wherein the first fluidic device is arranged at a first end of the tank and the second fluidic device is arranged at a second end of the tank, opposite the first end.

10. A method of sweep-purging a tank according to claim 8 by using a purging tool, wherein the method comprises the following steps:
connecting an outlet of the purging tool to the at least one second valve and connecting an inlet of the purging tool to the at least one first valve, simultaneously or in any order;
opening the at least one first valve and possibly opening the at least one second valve, simultaneously or in any order;
delivering new pressurized gas via the outlet of the purging tool and recovery of outgoing gas via the inlet of the purging tool, for a predetermined purging time;
closing the at least one first valve;
stopping a supply of the new pressurized gas when a desired gas pressure is reached in the tank;
optionally closing the at least one second valve.

11. The apparatus according to claim 1, wherein the pressurized gas comprises hydrogen.
